(19) United States
(12) Patent Application Publication
(10) Pub. No.: US 2026/0112828 A1
(43) Pub. Date: Apr. 23, 2026

(54) BOARD TO BOARD CONNECTOR ASSEMBLY

(71) Applicant: QIDONG LINKCONN ELECTRONICS CO., LTD., NANTONG (CN)

(72) Inventors: HAIGANG YIN, NANTONG (CN); YUELONG ZHU, NANTONG (CN)

(21) Appl. No.: 19/424,096

(22) Filed: Dec. 17, 2025

Related U.S. Application Data
(63) Continuation of application No. PCT/CN2024/099996, filed on Jun. 19, 2024.

(30) Foreign Application Priority Data
Jun. 19, 2023 (CN) 202310728371.0

(51) Int. Cl. H01R 12/71; H01R 12/70; H01R 13/405; H01R 13/621

(52) U.S. Cl. CPC H01R 12/716; H01R 12/7047; H01R 12/707; H01R 12/7082; H01R 13/405; H01R 13/6215

(57) ABSTRACT

A board-to-board connector assembly includes a first connector, a second connector and at least one screw. The first connector includes a first body and a pair of first brackets mounted at both longitudinal ends of the first body. The second connector includes a second body and a pair of second brackets mounted at both longitudinal ends of the second body. When the first connector is mated with the second connector, the first bracket preferentially contacts the second bracket. The first body includes at least one through slot, the second connector includes at least one metal fastener mounted on the second body, the metal fastener is in contact with the first bracket and defines a fastening hole; the screw has a screw rod with a thread, the screw rod passes through the through slot and engages with the fastening hole to lock the first connector and the second connector together.

### CROSS-REFERENCE TO RELATED APPLICATIONS

This present disclosure is a continuation application of International Application No. PCT/CN2024/099996, filed on June 19, 2024, which claims priority to Chinese Patent Application No. 202310728371.0, filed on June 19, 2023, with the Chinese Patent Office, the disclosures of which are incorporated herein by reference in their entireties.

### TECHNICAL FIELD

The present disclosure relates to a board-to-board connector assembly, and more particular to a board-to-board connector assembly with a self-locking structure.

### BACKGROUND

Board-to-board connectors are the connector products with the strongest transmission capacity among all types of connector products, mainly used in industries such as power systems, communication networks, financial manufacturing, elevators, industrial automation, medical equipment, office equipment, home appliances, military manufacturing, etc. Traditional board to board connectors are a pair, consisting of a male connector and a female connector that matches the male connector. The male connector and the female connector are respectively installed on the circuit board and combined by a tight fit.

The operator found that the existing board to board connectors are mainly locked by bracket during the work process. After multiple insertions and removals, the male and female connectors may experience varying degrees of material fatigue and deformation, which reduces the tightness of the connection between the male and female connectors. When the user accidentally pulls on the male or female connector, it is highly likely to cause the separation of the male and female connectors.

Hence, a new and simple board-to-board connector assembly is desired to improve those disclosed in the aforementioned proposal.

### SUMMARY OF THE INVENTION

Accordingly, the object of the present disclosure is a board-to-board connector assembly, includes a first connector and a second connector docked with the first connector. The first connector includes a first body extending in a longitudinal direction, a plurality of first terminals received in the first body and a pair of first brackets mounted at both longitudinal ends of the first body; the first body defines a first accommodating cavity, each first terminal has a first retaining portion fixed on the first body, a first contacting portion protruding from the first retaining portion into the first accommodating cavity and a first connection portion extending out of the first body. The second connector includes a second body extending in the longitudinal direction, a plurality of second terminals received in the second body and a pair of second brackets mounted at both longitudinal ends of the second body, the second body defines a second accommodating cavity, each second terminal has a second retaining portion fixed on the second body, a second contacting portion protruding from the second retaining portion into the second accommodating cavity and a second connection portion extending out of the second body. When the first connector is mated with the second connector, the first bracket preferentially contacts the second bracket; the first bracket defines a soldering portion, and the second bracket defines a soldering part. The first body includes at least one through slot, the second connector includes at least one metal fastener mounted on the second body, the metal fastener is in contact with the corresponding first bracket and defines a fastening hole; the board-to-board connector assembly includes at least one screw, the screw has a protruding screw rod with a thread, the screw rod passes through the through slot and engages with the fastening hole to lock the first connector and the second connector together.

Other objects, advantages and novel features of the disclosure will become more apparent from the following detailed description when taken in conjunction with the accompanying drawings.

### BRIEF DESCRIPTION OF THE DRAWINGS

FIG. 1 is a plan view of a board-to-board connector assembly in accordance with the present application.

FIG. 2 is a perspective view of a male connector of the present application.

FIG. 3 is a perspective view of a first base body of the male connector of FIG. 2.

FIG. 4 is a perspective view of a male seat bracket of the male connector of FIG. 2.

FIG. 5 is another perspective view of the male seat bracket of FIG. 4.

FIG. 6 is a perspective view of a female connector of the present application.

FIG. 7 is another perspective view of the female connector of FIG. 6.

FIG. 8 is a perspective view of a second base body of the female connector of FIG. 6.

FIG. 9 is another perspective view of the second base body of FIG. 8.

FIG. 10 is a perspective view of a female seat bracket of the female connector of FIG. 6.

FIG. 11 is another perspective view of the female seat bracket of FIG. 10.

FIG. 12 is a perspective view of a fastener of the female connector of FIG. 6.

FIG. 13 is another perspective view of the fastener of FIG. 12.

FIG. 14 is a perspective view of a screw of the board-to-board connector assembly of FIG. 1.

FIG. 15 is a front view of the screw of FIG. 14.

### DETAILED DESCRIPTION

Reference will now be made in detail to the preferred embodiment of the present disclosure.

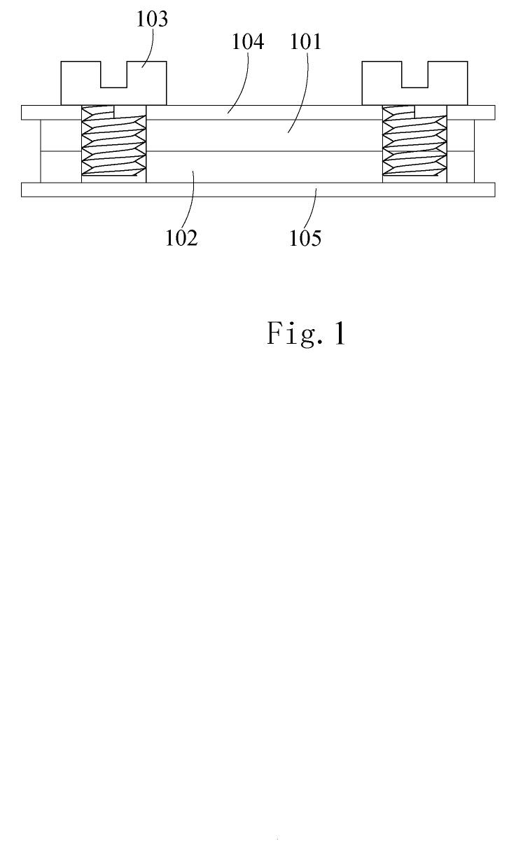

FIG. 1 shows a board-to-board connector assembly, which includes a male connector 101 and a female connector 102 that are docked together, and a pair of screws 103 for fastening the male connector 101 and the female connector 102 together. The male connector 101 is used to be mounted on a first circuit board 104 having a through hole therein, and the female connector 102 is used to be mounted on a second circuit board 105. Of course, the male connector 101 can also be defined as the first connector and the female connector 102 as the second connector, and vice versa, which can also solve the technical problem of the present invention. Therefore, the feature corresponding to the "male" described below can be defined as the "first", while the feature corresponding to the "female" as the "second". For example, the male bracket should be the first bracket, as the same applies below, and will not be described one by one here.

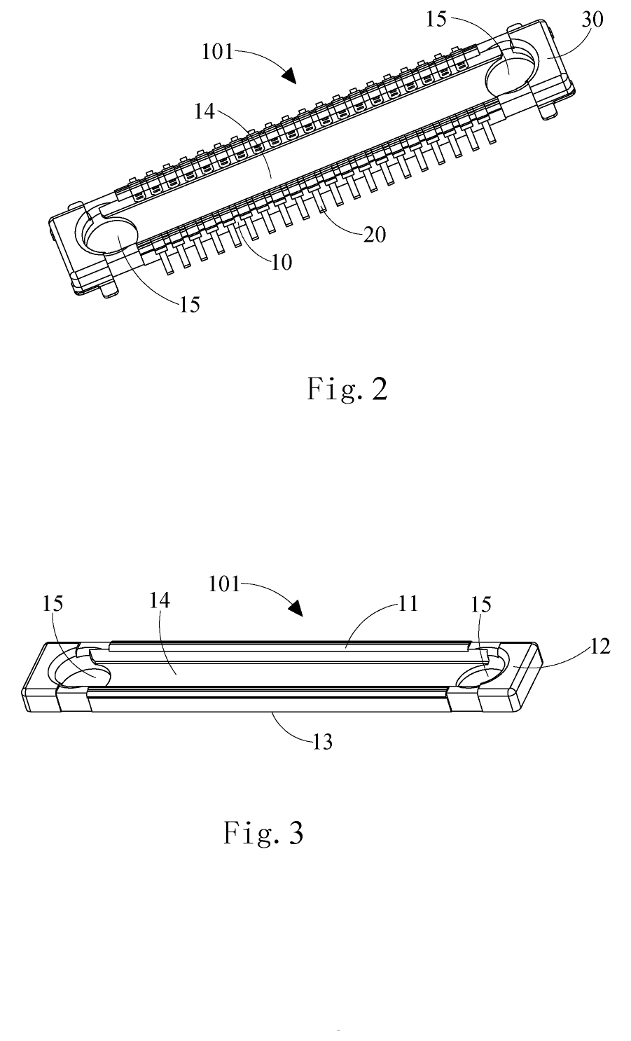

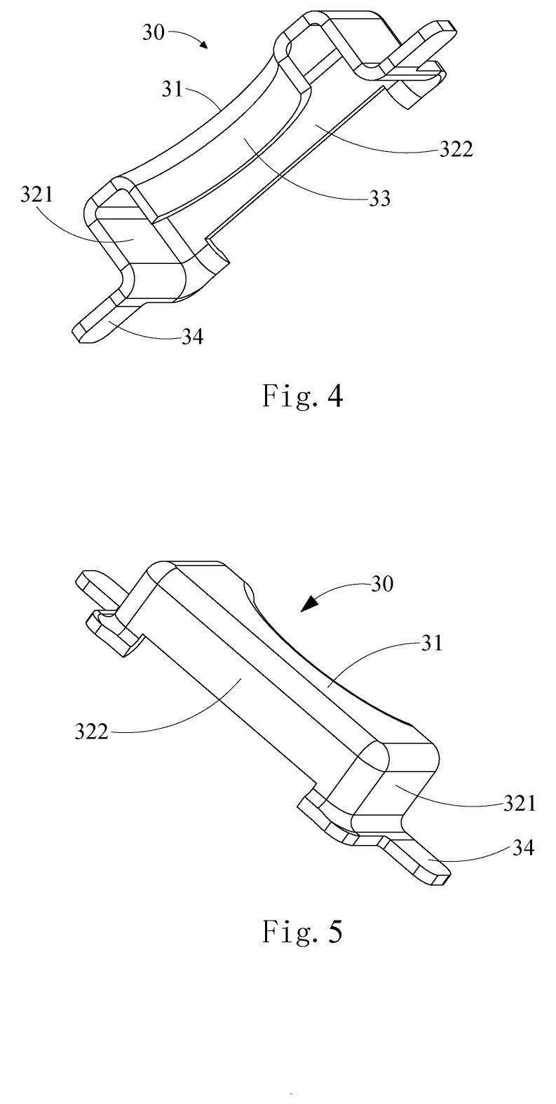

Referring to FIG. 1 to FIG. 5, the male connector 101 includes a first body 10 extending longitudinally, a plurality of first terminals 20 accommodated in the first body 10, and a pair of male brackets 30 fixed to the longitudinal ends of the first body 10. In this embodiment, the first body 10 is integrally injection molded with the first terminals 20, the first body 10 includes two longitudinally extending first side walls 11, two first end walls 12 connecting the two first side walls 11, a first bottom wall 13, and a male accommodating cavity 14 surrounded by the two first side walls 11, the two first end walls 12 and the first bottom wall 13. A pair of circular through slots 15 extending vertically through the first bottom wall 13 are respectively provided on the left and right sides of the first bottom wall 13, the through slots 15 are connected to the male accommodating cavity 14 and are adjacent to the first end walls 12.

The first terminals 20 are arranged in two rows, one by one on the first side wall 11, and are exposed in the male accommodating cavity 14. Each first terminal 20 defines a first retaining portion fixed on the first body 10, a first contacting portion protruding into the male accommodating cavity 14 from the first retaining portion and a first connection portion extending outside of the first body 10. The first contacting portion defines several friction parts to increase the stability of contact with the second terminal 60 of the female connector 102.

The male bracket 30 is a one-piece tensile structure that covers the first end wall 12 and its connection with the first side wall 11, reinforcing the structural strength of the first body 10. The male bracket 30 is also exposed in the male accommodating cavity 14. The male bracket 30 includes a bracket top wall 31, two first outer walls 321 extending vertically downward from the transverse outer edges of the bracket top wall 31, a second outer wall 322 extending vertically downward from the longitudinal outer edge of the bracket top wall 31, and an inner flange 33 extending vertically downward from the longitudinal inner edge of the bracket top wall 31. The bracket top wall 31 smoothly covers the top surface of the first side wall 11 and its connection with the first end wall 12. The two first outer walls 321 are vertically connected to the second outer wall 322, each covering the outer surface of the first side wall 11, and the second outer wall 322 covers the outer surface of the first end wall 12. The first outer wall 321 defines a horizontal soldering portion 34 extending outward from the bottom thereof and used for soldering onto the first circuit board 104. In other embodiments, the soldering portion 34 extends outward from the bottom of the second outer wall 322. The inner flange 33 is arc-shaped, and the inner surface of the inner flange 33 is coplanar with the inner surface of the through slot 15 of the first body 10, reducing the contact wear between screws 103 or metal fasteners 80 and plastic.

In this embodiment, the present application effectively distributes the locking strength by positioning the through slots 15 and the fasteners 80 at both ends of the male connector 101 and the female connector 102, respectively, to provide a better locking effect. The first outer walls 321 of the male bracket 30 have the horizontal soldering portions 34 protruding towards both sides. Because the male bracket 30 is a one-piece tensile structure, it provides greater strength, at the same time, the soldering portions 34 on both sides can firmly form a better holding effect with the first circuit board 104.

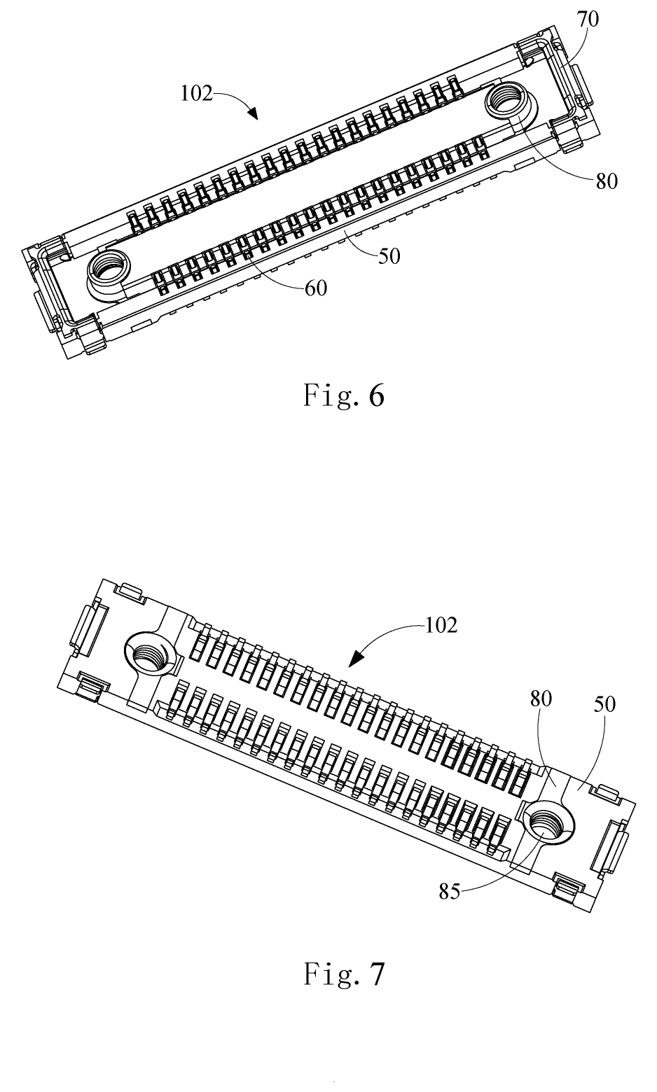

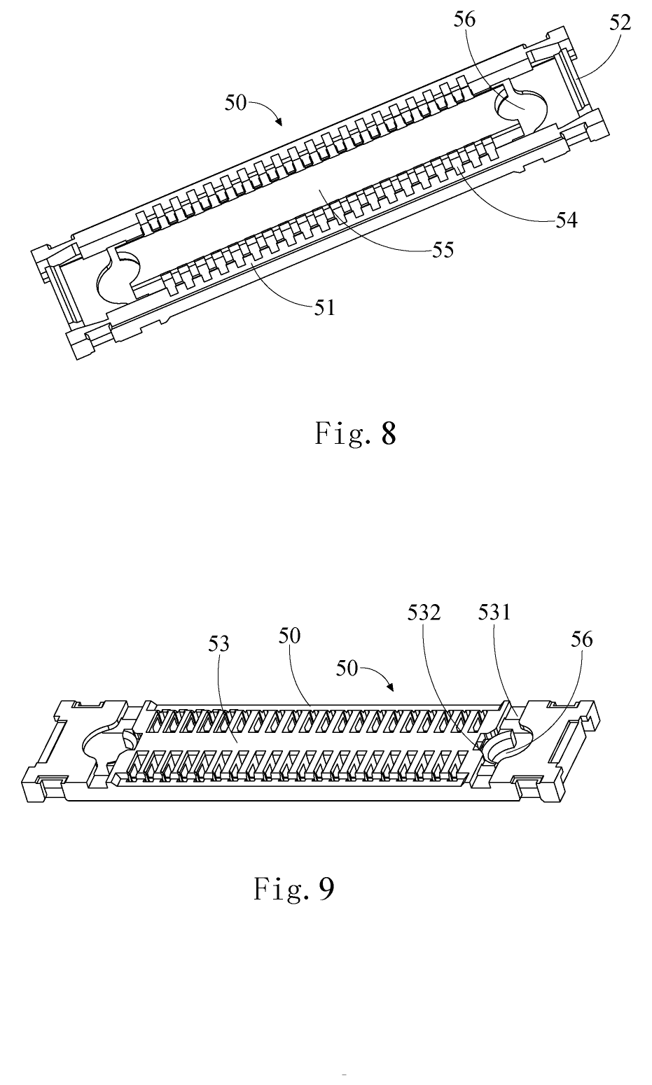

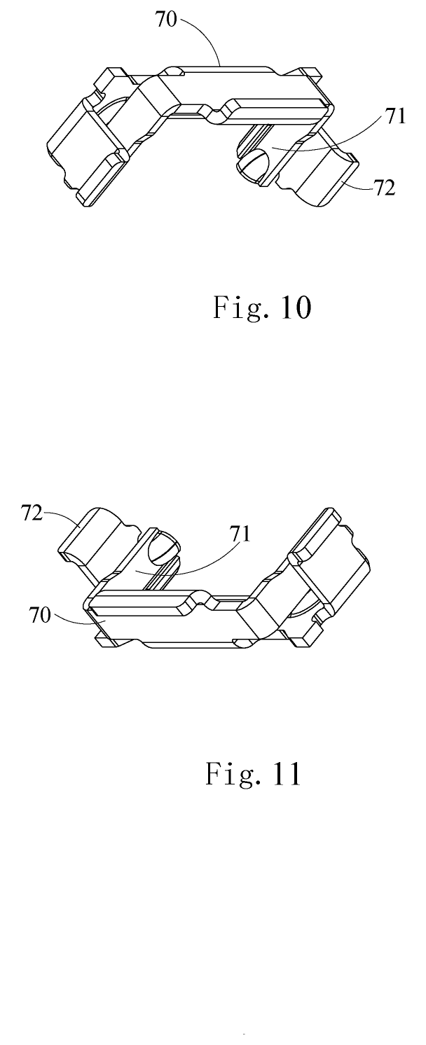

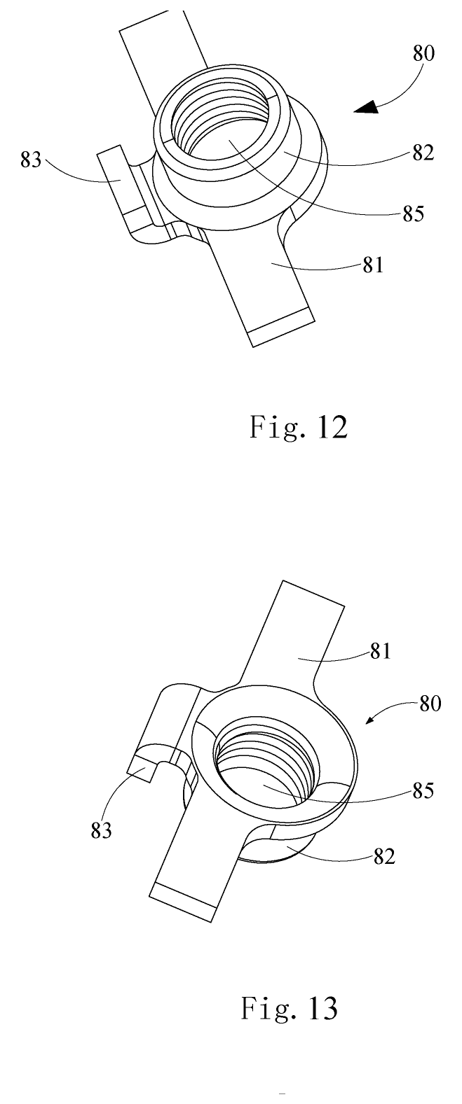

Referring to FIG. 6 to FIG. 13, the female connector 102 includes a longitudinally elongated second body 50, a plurality of second terminals 60 accommodated in the second body 50, a pair of female brackets 70 fixed to the longitudinal ends of the second body 50, and a pair of metal fasteners 80 fixed to the second body 50.

The second body 50 is made of injection molding of insulating material, which includes two second side walls 51 extending longitudinally, two second end walls 52 connecting the two second side walls 51, a second bottom wall 53, and a female accommodating cavity 54 surrounded by the two second side walls 51, the two second end walls 52 and the second bottom wall 53. The female accommodating cavity 54 defines a longitudinally central island portion 55, and the second body 50 defines a pair of fixing holes 56 that pass through the second bottom wall 53 and the central island portion 55 vertically. The fixing holes 56 are located at both ends of the longitudinal length of the central island portion 55. The bottom surface of the second bottom wall 53 is recessed with a fixing groove 531 and a plug-in groove 532 adjacent to the fixing groove 531.

The second terminals 60 are arranged in two rows, one by one on the second side wall 51 and the central island 55, and are exposed in the female accommodating cavity 54 to electrically connect with the first terminals 20 of the male connector 101, achieving data transmission. The female bracket 70 covers the second end wall 52 and its connection with the second side wall 51. The female bracket 70 includes an elastic arm 71 extending longitudinally into the female accommodating cavity 54 and a soldering part 72 for soldering to the second circuit board 105, the elastic arm 71 is capable of elastically swinging laterally.

The second terminal 60 defines a second retaining portion fixed on the second body 50, a second contacting portion protruding into the female accommodating cavity 54 from the second retaining portion and a second connection portion extending outside of the second body 50, the second contacting portion is elastically disposed.

The metal fastener 80 includes a main body portion 81 and an annular sleeve portion 82 stretched upward from the main body portion 81. The main body portion 81 is fixed in the fixing groove 531, and the outer edge of the main body portion 81 is provided with an upwardly bent plug piece 83, the plug piece 83 is inserted upward and fixed in the plug-in groove 532. The sleeve portion 82 is fixed in the fixing hole 56, the sleeve portion 82 is enclosed to form a fastening hole 85, and the inner wall of the fastening hole 85 is provided with a thread.

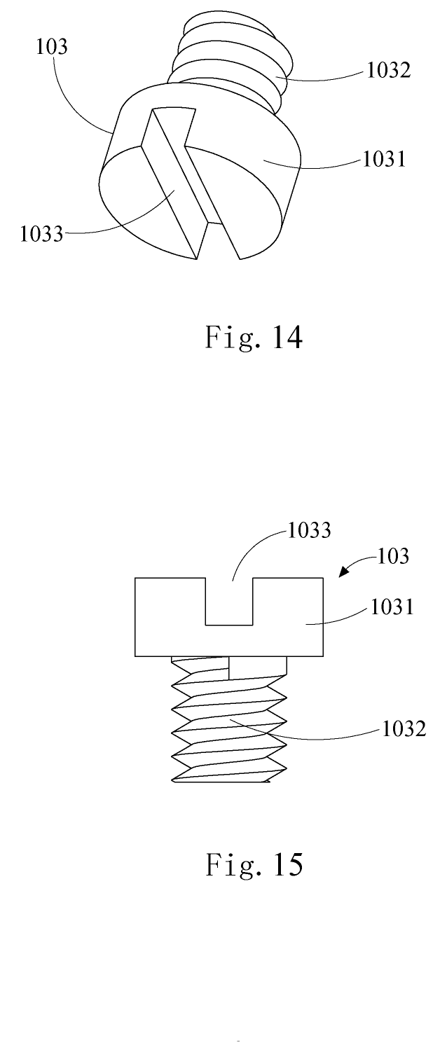

Referring to FIG. 14 to FIG. 15, the screw 103 includes a screw head 1031 and a screw rod 1032 extending from the screw head 1031. The diameter of the screw head 1031 is larger than that of the screw rod 1032. A narrow slot 1033 for operating a special jig is provided on the top surface of the screw head 1031, and the screw 1032 is provided with a thread.

Referring to FIG.1, when the male connector 101 is installed on the first circuit board 104 and the female connector 102 is installed on the second circuit board 105, the male connector 101 and the female connector 102 are docked together, the male bracket 30 and the female bracket 70 come into contact preferentially, reducing the wear and tear caused by the contact between the first body 10 and the second body 50.

The central island portion 55 of the female connector 102, together with the sleeve portion 82 of the fastener 80, is inserted into the male accommodating cavity 14 of the male connector 101, the sleeve portion 82 is also in contact with the inner flange 33 of the male bracket 30. The first terminal 20 and the second terminal 60 are in electrical contact with each other. The male bracket 30 of the male connector 101 enters the female accommodating cavity 54 of the female connector 102, and the elastic arm 71 of the female bracket 70 presses against the outer surface of the first outer wall 321 of the male bracket 30, so that the male bracket 30 and the female bracket 70 are in electrical contact with each other. With this design, the male bracket 30, the female bracket 70, the fastener 80, and the screw 103 are electrically connected together, which is conducive to extracting noise and improving signal transmission quality.

The through slot 15 of the first body 10, the through-hole on the first circuit board 104, and the fastening hole 85 of the female connector 102 are aligned backwards. The screw rod 1032 of the screw 103 passes through the through-hole and the through slot 15 and is engaged with the fastening hole 85. The screw head 1031 is pressed against the first circuit board 104 or the first body 10, at least partially accommodated in the through-hole, and the male connector 101 and the female connector 102 are locked together to achieve self-locking function. The locking effect is reliable and easy to achieve, the male connector 101 and the female connector 102 can only be separated by disassembly with a special jig. Compared with the existing technical solution that only uses bracket locking, the screw 103 of the present application is locked with the fastening hole 85 of the metal fastener 80, which can achieve better locking effect and prevent the connector from accidentally disengaging due to collision or falling. In addition, the inner flange 33 is used to guide the insertion of the female bracket 70 of the female connector 102, which not only reduces the wear of the screw 103 on the male connector 101, but also forms an electrical connection between the male bracket 30 and the screw 103, which can provide better shielding effect and improve transmission quality after docking with the female connector.

However, the disclosure is illustrative only, changes may be made in detail, especially in matter of shape, size, and arrangement of parts within the principles of the disclosure.

What is claimed is:

1. A board-to-board connector assembly, comprising:
a first connector, including a first body extending in a longitudinal direction, a plurality of first terminals received in the first body and a pair of first brackets mounted at both longitudinal ends of the first body; the first body defining a first accommodating cavity, each first terminal having a first retaining portion fixed on the first body, a first contacting portion protruding from the first retaining portion into the first accommodating cavity and a first connection portion extending out of the first body; and
a second connector mated with the first connector, the second connector including a second body extending in the longitudinal direction, a plurality of second terminals received in the second body and a pair of second brackets mounted at both longitudinal ends of the second body, the second body defining a second accommodating cavity, each second terminal having a second retaining portion fixed on the second body, a second contacting portion protruding from the second retaining portion into the second accommodating cavity and a second connection portion extending out of the second body;
when the first connector is mated with the second connector, the first bracket preferentially contacts the second bracket; the first bracket defines a soldering portion, and the second bracket defines a soldering part;
wherein the first body includes at least one through slot extending vertically through the first body, the second connector includes at least one metal fastener mounted on the second body, the metal fastener is in contact with the corresponding first bracket and defines a fastening hole; the board-to-board connector assembly includes at least one screw, the screw has a protruding screw rod with a thread, the screw rod passes through the through slot and engages with the fastening hole to lock the first connector and the second connector together.

2. The board-to-board connector assembly according to claim 1, wherein the first bracket includes a bracket top wall and an inner flange extending downwardly and vertically from a longitudinal inner edge of the bracket top wall, and the metal fastener is in electrical contact with the inner flange.

3. The board-to-board connector assembly according to claim 2, wherein the first body includes two first side walls extending longitudinally, two first end walls connecting the two first side walls and a first bottom wall, the first accommodating cavity is formed by the two first side walls, the two first end walls and the first bottom wall, the smooth surface of the first bracket covers the first end wall and the connection between the first end wall and the first side wall.

4. The board-to-board connector assembly according to claim 3, wherein the first bracket also includes two first outer walls extending vertically downward from the two lateral outer edges of the bracket top wall and a second outer wall extending vertically downward from the longitudinal outer edge of the bracket top wall, the bracket top wall, the first outer wall and the second outer wall form a seamless connection, the second bracket includes an elastic arm in electrical contact with the first outer wall.

5. The board-to-board connector assembly according to claim 2, wherein the inner flange is arc-shaped, and the inner surface of the inner flange is coplanar with the inner surface of the through slot.

6. The board-to-board connector assembly according to claim 1, wherein the second body defines a central island portion located in the second accommodating cavity, two metal fasteners are provided and are respectively located at the longitudinal ends of the central island portion, and the central island portion together with the metal fasteners are inserted into the first accommodating cavity.

7. The board-to-board connector assembly accordingly to claim 1, wherein the metal fastener includes a main body portion and an annular sleeve portion stretched from the main body portion, the sleeve portion surrounds the fastening hole, and the sleeve portion is in electrical contact with the first bracket.

8. The board-to-board connector assembly according to claim 7, wherein the sleeve portion is stretched upward from the main body portion, and the bottom surface of the second body is provided with a fixing groove for fixing the main body portion.

9. The board-to-board connector assembly according to claim 8, wherein the bottom surface of the second body is provided with a plug-in groove close to the fixing groove, and the outer edge of the main body portion is provided with a plug piece bent and extended upward, and the plug piece is inserted upward and fixed in the plug-in groove.

10. A board-to-board connector assembly, comprising:
a first connector, including a first body extending in a longitudinal direction and a plurality of first terminals received in the first body; the first body defining a first accommodating cavity, each first terminal having a first retaining portion fixed on the first body, a first contacting portion protruding from the first retaining portion into the first accommodating cavity and a first connection portion extending out of the first body; and
a second connector mated with the first connector, the second connector including a second body extending in the longitudinal direction and a plurality of second terminals received in the second body, the second body defining a second accommodating cavity, each second terminal having a second retaining portion fixed on the second body, a second contacting portion protruding from the second retaining portion into the second accommodating cavity and a second connection portion extending out of the second body;
wherein the first body includes at least one through slot extending vertically through the first body, the second connector includes at least one metal fastener mounted on the second body, the metal fastener defines a fastening hole; the board-to-board connector assembly includes at least one screw, the screw has a protruding screw rod with a thread, the screw rod passes through the through slot and engages with the fastening hole to lock the first connector and the second connector together.

11. The board-to-board connector assembly according to claim 10, wherein the second body defines a central island portion located in the second accommodating cavity, two metal fasteners are provided and are respectively located at the longitudinal ends of the central island portion, and the central island portion together with the metal fasteners are inserted into the first accommodating cavity.

12. The board-to-board connector assembly accordingly to claim 11, wherein the metal fastener includes a main body portion and an annular sleeve portion stretched from the main body portion, the sleeve portion is stretched upward from the main body portion and surrounds the fastening hole.

13. The board-to-board connector assembly according to claim 12, wherein the second body defines a pair of fixing holes that pass through the central island portion vertically, the fixing holes are located at both ends of the longitudinal length of the central island portion and communicating within the second accommodating cavity, the sleeve portions of two metal fasteners are respectively located in the corresponding fixing holes.

14. The board-to-board connector assembly according to claim 13, wherein the bottom surface of the second body is provided with a fixing groove for fixing the main body portion and a plug-in groove close to the fixing groove, and the outer edge of the main body portion is provided with a plug piece bent and extended upward, and the plug piece is inserted upward and fixed in the plug-in groove.

15. The board-to-board connector assembly according to claim 10, wherein the first connector includes a pair of first brackets mounted at both longitudinal ends of the first body, the second connector includes a pair of second brackets mounted at both longitudinal ends of the second body, when the first connector is mated with the second connector, the first bracket preferentially contacts the second bracket; the first bracket includes a bracket top wall and an inner flange extending downwardly and vertically from a longitudinal inner edge of the bracket top wall, and the metal fastener is in electrical contact with the inner flange of the first bracket.

16. A board-to-board connector assembly, comprising:
a first connector, including a first body extending in a longitudinal direction, a plurality of first terminals received in the first body and a pair of first brackets mounted at both longitudinal ends of the first body; and
a second connector mated with the first connector, the second connector including a second body extending in the longitudinal direction, a plurality of second terminals received in the second body and a pair of second brackets mounted at both longitudinal ends of the second body;
when the first connector is mated with the second connector, the first bracket preferentially contacts the second bracket; the first bracket defines a soldering portion, and the second bracket defines a soldering part;
wherein the first body includes at least one through slot extending vertically through the first body, the second connector includes at least one metal fastener mounted on the second body, the metal fastener is in contact with the corresponding first bracket and defines a fastening hole; the board-to-board connector assembly includes at least one screw, the screw has a protruding screw rod with a thread, the screw rod passes through the through slot and engages with the fastening hole to lock the first connector and the second connector together.

17. The board-to-board connector assembly according to claim 16, wherein the first bracket includes a bracket top wall and an inner flange extending downwardly and vertically from a longitudinal inner edge of the bracket top wall, and the metal fastener is in electrical contact with the inner flange.

18. The board-to-board connector assembly according to claim 17, wherein the inner flange is arc-shaped, and the inner surface of the inner flange is coplanar with the inner surface of the through slot.

19. The board-to-board connector assembly according to claim 16, wherein the second body defines a central island portion extending in the longitudinal direction and a pair of fixing holes that pass through the central island portion vertically, the fixing holes are located at both ends of the longitudinal length of the central island portion, two metal fasteners are provided and are respectively located in the corresponding fixing holes.

20. The board-to-board connector assembly accordingly to claim 19, wherein the metal fastener includes a main body portion and an annular sleeve portion stretched from the main body portion, the sleeve portion is stretched upward from the main body portion and surrounds the fastening hole, and the sleeve portion is in electrical contact with the first bracket.
